(19) United States
(12) Patent Application Publication
(10) Pub. No.: US 2026/0142738 A1
(43) Pub. Date: May 21, 2026

(54) Timing Distribution in a Variable Wireless Environment

(71) Applicant: Rampart Communications, Inc., Linthicum Heights, MD (US)

(72) Inventor: Jarriel D. Cook, Cheverly, MD (US)

(21) Appl. No.: 18/950,852

(22) Filed: Nov. 18, 2024

(51) Int. Cl. H04J 3/06; H04W 56/00; H04W 64/00

(52) U.S. Cl. CPC H04J 3/0667; H04W 56/005; H04W 64/00

(57) ABSTRACT

A computer-implemented method maintains time synchronization over a wireless connection through variable operational conditions. The wireless device determines an operating mode based on the operational conditions of the wireless device. When the wireless device receives a time synchronization message from a remote device, the wireless device determines a clock offset between its local clock and a remote clock of the remote device. The clock offset is based on the operating mode and information in the time synchronization message. The wireless device adjusts its local clock to mitigate the clock offset from the remote clock. The wireless device also determines timing window(s) based on the local clock and receives a wireless data message beginning within a first timing window.

### TECHNICAL FIELD

The present disclosure relates to time synchronization in wireless communication, especially in uncertain environments.

### BACKGROUND

Wireless devices maintain local clocks for transmitting outgoing signals and sampling incoming wireless signals. The local clocks of a pair of wireless devices may drift apart, for example, due to different component specifications, ambient temperature conditions, and/or different circuit designs. Accurate timing synchronization between wireless devices enables more efficient, more secure, and higher throughput communication. To mitigate effects of local clocks drifting apart, one of the wireless devices may periodically adjust its local clock.

### BRIEF DESCRIPTION OF THE DRAWINGS

FIG. 1 is simplified block diagram of a wireless network system configured to distribute a time synchronization message, according to an example embodiment.

FIG. 2A is a timing diagram that illustrates a wireless transmission from a transmitter device to different receiver devices, according to an example embodiment.

FIG. 2B illustrates a timing window for wireless communications between wireless devices, according to an example embodiment.

FIG. 3 illustrates a state diagram illustrating transitions between operating modes of a wireless receiver device, according to an example embodiment.

FIG. 4A is a message flow diagram illustrating communications between wireless devices to resynchronize clocks in a coarse unidirectional mode of operation, according to an example embodiment.

FIG. 4B is a message flow diagram illustrating communications between wireless devices to resynchronize clocks in a fine unidirectional mode of operation, according to an example embodiment.

FIG. 5 is a message flow diagram illustrating communications between wireless devices to resynchronize clocks in a bidirectional mode of operation, according to an example embodiment.

FIG. 6A illustrates a header formatted in a Burst Time Distribution Protocol (BTDP) protocol, according to an example embodiment.

FIG. 6B illustrates a time synchronization message formatted in BTDP, according to an example embodiment.

FIG. 7 is a flowchart illustrating operations performed by wireless device to adjust a local clock based on an operating mode defined by the environment of the wireless device, according to an example embodiment.

FIG. 8 is a block diagram of a computing device that may be configured to perform the techniques presented herein, according to an example embodiment.

### DETAILED DESCRIPTION

### Overview

A computer-implemented method is provided for maintaining time synchronization over a wireless connection. The method includes determining an operating mode of a wireless device based on operational conditions of the wireless device. When the wireless device receives a time synchronization message from a remote device, the method also includes determining a clock offset between a local clock of the wireless device and a remote clock of the remote device. The clock offset is based on the operating mode and information in the time synchronization message. The method further includes adjusting the local clock of the wireless device to mitigate the clock offset between the local clock and the remote clock. The method also includes determining at least one timing window based on the local clock and receiving a wireless data message beginning within a first timing window of the at least one timing window.

### DESCRIPTION OF EMBODIMENTS

Timing synchronization protocols, such as Network Time Protocol (NTP) or Precision Time Protocol (PTP), enable two computing devices to determine a clock offset between their respective local clocks. By adjusting a local clock to mitigate the clock offset, a receiver device may match the remote clock of a transmitter device. With a common time standard, the receiver device may improve the reliability of a received message (e.g., by critically sampling at the appropriate time) and improve the security of a communication session (e.g., through the use of time-defined cryptographic material).

However, timing synchronization protocols typically require minimum capabilities of each computing device to ensure that each computing device is operating with a synchronized clock. For instance, NTP and PTP calculate a clock offset through a message exchange, which requires each computing device to be able to transmit and receive messages. In an operational environment that precludes at least one of the devices from transmitting and/or receiving, typical time synchronization protocols may fail.

In one example, the techniques described herein loosen timing requirements between the transmitter devices and receiver devices through the use of timing windows in a Burst Time Distribution Protocol (BTDP). The timing windows enable a transmitter and receiver to send time synchronized messages as long as the receiver receives the message in the same time window. In other words, the transmitter and receiver devices do not need to maintain the exact same clock, as long as the clock offset between the two devices remains within the same timing window. Using timing windows allows the wireless devices to gracefully degrade in time synchronization as supporting functions and abilities fail.

The techniques presented herein enable computing devices to seamlessly shift between time synchronization operating modes depending on the operational conditions of the computing devices. When the operational conditions allow bidirectional communication between a first device and a second device, the second device may determine a clock offset from the first device based on a time synchronization exchange (e.g., PTP). If the operational conditions put a restriction on the second device transmitting messages (e.g., to maintain secrecy/security or due to adversarial actions), then the second device shifts to an operating mode based on receiving transmissions from the first device and other metadata (e.g., position information) that may be available to the second device. If the operational conditions also put a restriction on the second device receiving messages from the first device, then the second device may enter an unsynchronized mode. The unsynchronized mode may direct the second device to calculate a length of time before the clock drift between the first device and the second device prevents the second device from reestablishing synchronized timing windows with a new synchronization message from the first device. In other words, the unsynchronized mode calculates how long the second device can wait to receive a synchronization message from the first device that refreshes the time synchronization of the timing windows.

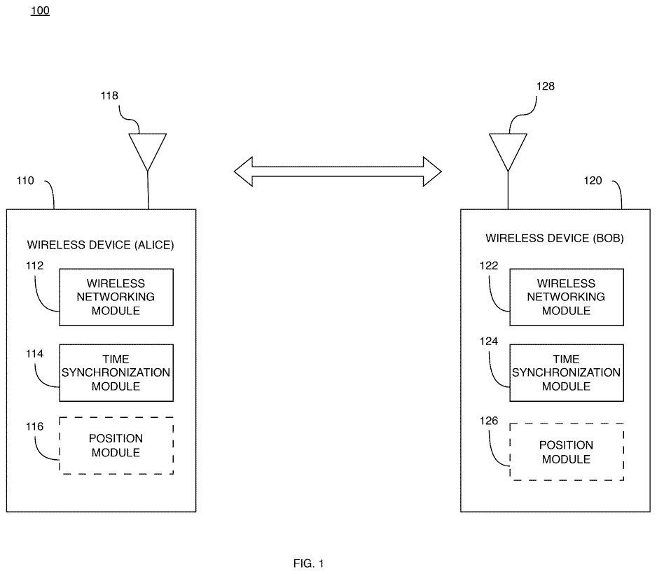

Referring now to FIG. 1, a simplified block diagram illustrates a wireless communication system 100 configured to gracefully transition between operating modes based on the operational conditions of the system 100. The wireless communication system 100 includes a first wireless device 110, which may also be referred to herein as a transmitter device or Alice. The first wireless device 110 includes a wireless networking module 112 that enables the first wireless device 110 to process communications signals and exchange information with other computing devices over a wireless network. The first wireless device 110 also includes a time synchronization module 114 configured to maintain a common clock reference (e.g., through the BTDP techniques described herein) with at least one other computing device. The first wireless device 110 may also include a position module 116 that enables the first wireless device 110 to determine its physical location (e.g., through a satellite positioning system). The first wireless device 110 may further include an antenna 118 that enables the first wireless device 110 to transmit/receive wireless signals to/from other computing devices.

The wireless communication system 100 also includes a second wireless device 120, which may also be referred to herein as a receiver device or Bob. The second wireless device 120 includes a wireless networking module 122 that enables the second wireless device 120 to process communications signals and exchange information with other computing devices over a wireless network. The second wireless device 120 also includes a time synchronization module 124 configured to maintain a common clock reference (e.g., through the BTDP techniques provided herein) with at least one other computing device (e.g., first wireless device 110). The second wireless device 120 may also include a position module 126 that enables the second wireless device 120 to determine its physical location (e.g., through a positioning system). The second wireless device 120 may further include an antenna 128 that enables the second wireless device 120 to transmit/receive wireless signals to/from other computing devices (e.g., first wireless device 110).

In one example, the first wireless device 110 and/or second wireless device 120 may be embodied in a laptop computer, a desktop computer, a server, a network device, an Internet of Things (IoT) device, a mobile phone, a radio, any other wireless device, or an accessory device to any of the preceding devices. At least one of the wireless devices 110 and 120 may be integrated into larger computing systems, such as a data center or cloud computing environment.

In another example, the wireless networking module 112 and the wireless networking module 122 may further include a software defined radio that enables the first wireless device 110 and the second wireless device 120, respectively, to adjust the parameters (e.g., frequency, amplitude, power, timing, etc.) of the wireless signals transmitted via the antenna 118 and the antenna 128.

In a further example, the first wireless device 110 and the second wireless device 120 may communicate via a computer network, such as a Local Area Network (LAN), a Wide Area Network (WAN), a private network, a Virtual Private Network (VPN), a Metropolitan Area Network (MAN), a Personal Area Network (PAN), a Wireless LAN (WLAN), a Wireless WAN (WWAN), a cellular network, and/or combinations thereof. The computer network between the first wireless device 110 and the second wireless device 120 may include segments over wired and/or wireless channels, such as Radio Frequency (RF) channels, Extremely Low Frequency (ELF) channels, Ultra Low Frequency (ULF) channels, Low Frequency (LF) channels, Medium Frequency (MF) channels, High Frequency (HF) channels, Very High Frequency (VHF) channels, Ultra High Frequency (UHF) channels, Extremely High Frequency (EHF) channels, and/or satellite channels. The computer network between the first wireless device 110 and the second wireless device 120 may also include one or more segments over optical networks (e.g., based on Synchronous Optical Networking (SONET), Synchronous Digital Hierarchy (SDH), or Optical Transport Network (OTN) protocols).

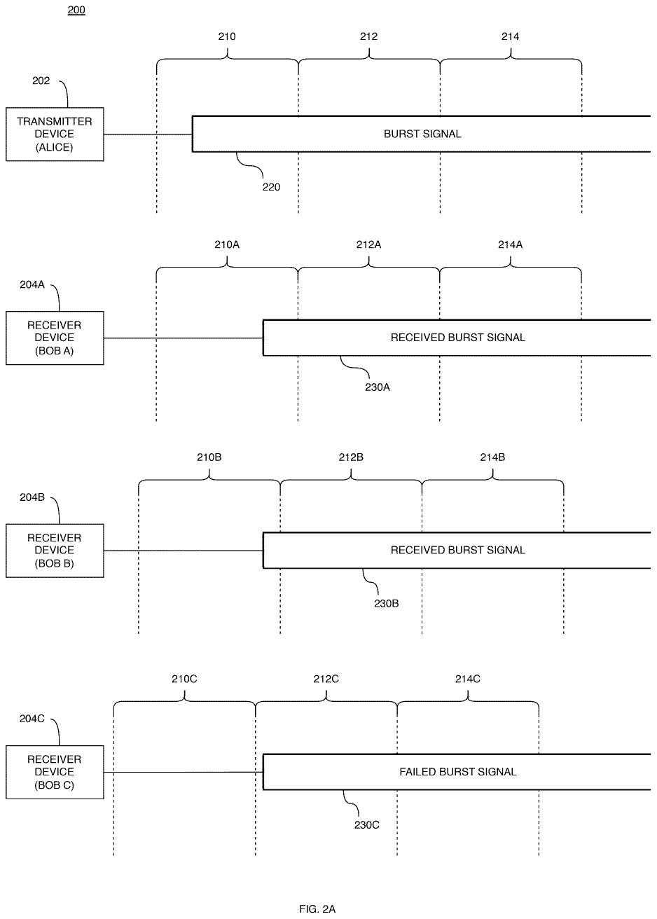

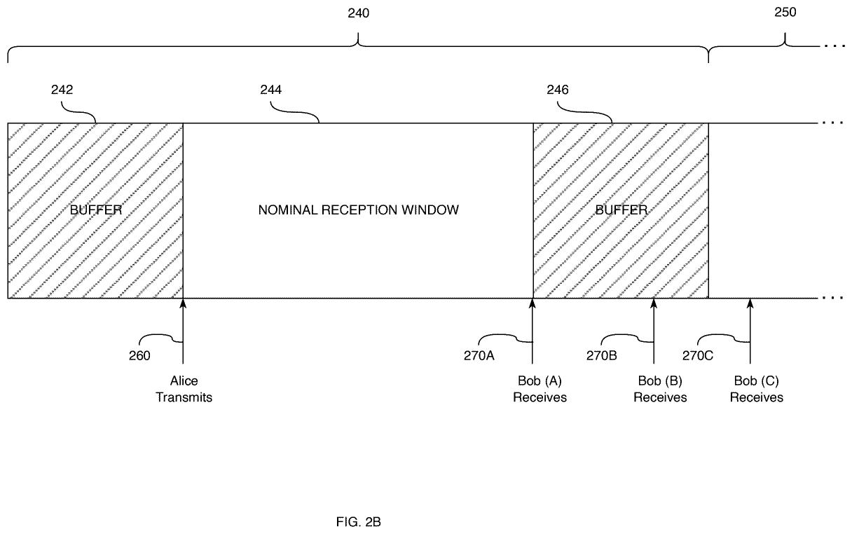

Referring now to FIG. 2A, a timing diagram 200 illustrates an example of a BTDP timing window approach for wirelessly communicating in an uncertain operating environment. The timing diagram 200 includes a transmitter device 202 (e.g., a first wireless device 110) and receiver devices 204A, 204B, and 204C (e.g., second wireless device 120), which are at a distance from the transmitter device 202. The timing diagram 200 shows timing windows 210, 212, and 214 for the transmitter device. The timing diagram 200 also shows timing windows 210A-210C, 212A-212C, and 214A-214C associated with corresponding receiver devices 204A-204C. Each timing window is associated with a set of parameters (e.g., modulation, coding, cryptography, etc.) that enables a receiver device to correctly receive a message. When a receiver device detects a signal beginning in a particular timing window, the receiver device attempts to process (e.g., demodulate, decode, decrypt, etc.) the received signal using the corresponding parameters of that particular timing window. Receiving a message outside of the timing window corresponding to the timing window in which it was transmitted leads to the receiving device attempting to receive the message with the wrong parameters. In other words, if a message is received in a different timing window due to, for instance, a clock offset between the transmitter device and the receiver device, then the receiver device may not be able to receive any information from the message.

Each of the timing windows is determined based on a local clock for each device. In other words, the local clock in the transmitter device 202 determines the timing windows 210, 212, and 214. The local clock in the receiver device 204A determines the timing windows 210A, 212A, and 214A. Similarly, the local clock in the receiver device 204B determines the timing windows 210B, 212B, and 214B. The local clock in the receiver device 204C determines the timing windows 210C, 212C, and 214C.

At a predetermined time in the timing window 210, the transmitter device 202 transmits a burst signal 220, which may include information that has been modulated, encoded, and or encrypted according to parameters associated with the timing window 210. The receiver device 204A detects the corresponding signal 230A at a later time within its corresponding timing window 210A. With the parameters associated with the timing windows 210 and 210A, the receiver device 204A may recover the information from the received signal 230A. Similarly, the receiver device 204B detects the corresponding signal 230B within the corresponding timing window 210B, and may recover the information in the received signal 230B.

In contrast, the receiver device 204C detects the corresponding signal 230C in the timing window 212C, which does not correspond to the transmitted timing window 210. The receiver device 204C attempts to process the received signal 230C based on the parameters associated with the timing window 212C, since that is the timing window in which the receiver device 204C detected the signal 230C. However, if the parameters associated with the timing windows 210 and 210C do not match the parameters associated with the timing windows 212 and 212C, then the receiver device 204C may not be able to recover the information in the received signal 230C. In other words, the receiver device 204C detected the signal 230C in a timing window 212C that corresponds to a timing window 212 that is different than the timing window 210 in which the transmitter device 202 began transmitting the burst signal 220, causing the burst transmission to fail.

In one example, the transmitted burst signal 220 and the corresponding received signals 230A-230C may be longer than an individual timing window. As long as the receiving device (e.g., one of the receiver devices 204A-204C) begins to receive the corresponding signal (e.g., one of the received signals 230A-230C) within the timing window corresponding to the timing window that the transmitter device 202 began transmitting the burst signal 220, then the receiving device will process the received signal according to the correct parameters associated with the timing window.

As shown in FIG. 2A, the propagation delay between the transmitter device 202 transmitting the burst signal 220 and each of the receiver devices 204A-204C receiving the corresponding signals 230A-230C is shown as a constant. Effectively, each of the receiver devices 204A-204C are essentially the same distance from the transmitter device 202, and each of the receiver devices 204A-204C receives the corresponding signal 230A-230C at the same time on an objectively observed time scale.

Additionally, FIG. 2A illustrates the clock offset between the local clock of the transmitter device 202 and each of the receiver devices 204A-204C by shifting the timing windows associated with each receiver device. The local clock of the receiver device 204A is well synchronized with the local clock of the transmitter device 202, and the timing windows 210, 212, and 214 of the transmitter device 202 match the timing windows 210A, 212A, and 214A of the receiver device 204A.

In contrast, the local clock of the receiver device 204B differs slightly from local clock of the transmitter device 202, and the timing windows 210, 212, and 214 are slightly shifted from the corresponding timing windows 210B, 212B, and 214B. However, the clock offset between the local clock of the transmitter device 202 and the local clock of the receiver device 204B is small enough that the receiver device 204B can still recover the information from the received signal 230B, since the signal 230B is received in the timing window 210B corresponding to the timing window 210 in which the transmitter device 202 began transmitting the burst signal 220.

The local clock of the receiver device 204C differs significantly from the local clock of the transmitter device 202, and the timing windows 210, 212, and 214 are significantly shifted from the corresponding timing windows 210C, 212C, and 214C. The clock offset between the local clock of the transmitter device 202 and the local clock of the receiver device 204C is large enough that the receiver device 204C detects the signal 230C beginning in a different timing window 212C, which does not correspond to the timing window 210 in which the transmitter device 202 began transmitting the burst signal 220. With the receiver device 204C detecting the signal 230C in a non-corresponding timing window 212C, the receiver device 204C may not be able to correctly process the signal 230C to recover the information transmitted in the burst signal 220.

Referring now to FIG. 2B, an example of the construction of a timing window 240 is shown. The timing window 240 includes an initial buffer 242, a nominal reception window 244, and a final buffer 246. Another timing window 250 follows after the final buffer 246 of the timing window 240. For continued reference to elements of FIG. 2A, the timing window 240 corresponds to each of timing windows 210, 210A, 210B, and 210C as determined by the local clock of the transmitter device 202 and the receiver devices 204A, 204B, and 204C, respectively.

As shown in FIG. 2A, the transmitter device 202 (e.g., Alice) begins transmitting the burst signal 220 at the beginning 260 of the nominal reception window 244. The receiver device 204A (e.g., Bob A) detects the signal 230A near the end 270A of the nominal reception window 244. The receiver device 204B (e.g., Bob B) detects the signal 230B in the final buffer 246 at 270B. The receiver device 204C (e.g., Bob C) detects the signal 230C at 270C in the following timing window 250 after the final buffer 246.

In one example, the lengths of the initial buffer 242, the nominal reception window 244, and/or the final buffer 246 may be determined by design parameters of one or more expected use cases of the wireless communication system. For instance, the length of the nominal reception window 244 may be determined by a maximum operating range for the wireless communication system. In other words, the length of the nominal reception window 244 may be determined by the propagation delay at the maximum range between the transmitter device and the receiver device. Similarly, the lengths of the initial buffer 242 and/or the final buffer 246 may be determined by an amount of clock offset between the local clocks of transmitters and receivers that the wireless transmission system may be designed to tolerate.

Increasing the designed length of the nominal reception window 244 allows for the wireless communication system to operate at longer ranges, at the expense of a longer timing window 240. Similarly, increasing the length of the initial buffer 242 and/or the final buffer 246 allows the wireless communication system to tolerate a larger clock offset, also at the expense of a longer timing window 240. Since transmitter devices are only configured to transmit at the beginning of each timing window, increasing the designed length of the timing window decreases how often a transmitter device is allowed to begin a transmission, which may negatively impact the performance (e.g., latency, throughput, etc.) of the wireless link.

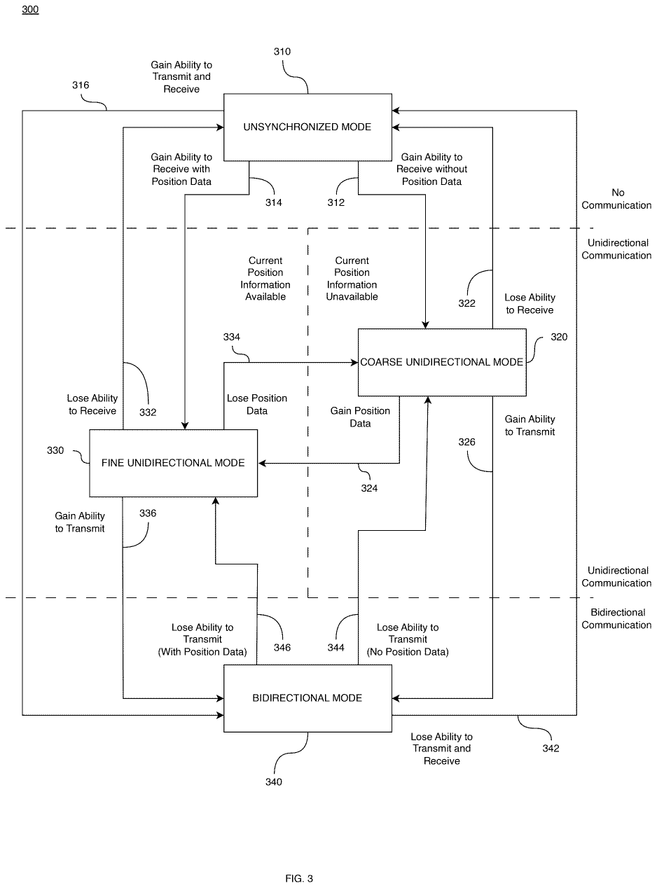

Referring now to FIG. 3, a state diagram 300 illustrates operating modes of a receiver device Bob (e.g., a second wireless device 120) and transitions between different operating modes. The state diagram 300 includes an unsynchronized mode 310, a coarse unidirectional mode 320, a fine unidirectional mode 330, and a bidirectional mode 340. The operational conditions of Bob and the support functions (e.g., positioning systems, wireless reception, wireless transmission, etc.) available to Bob determine the operating mode of Bob.

In the unsynchronized mode 310, Bob has minimal or no support functions available. In particular, Bob has restrictions on the ability to receive/send wireless transmissions from/to a transmitter device Alice (e.g., a first wireless device 110) configured to provide timing synchronization. Without the ability to resynchronize its local clock, Bob may determine a minimum time to error (MTE) based on hardware specifications and design parameters of the timing window. For instance, the minimum time to error may be calculated as:

$$MTE = \frac{{min}_{init , final} [ {T}_{buffer} ]}{{ε}_{T x} + {ε}_{R x}} , \qquad ( 1 )$$

where T_{buffer} is the length of the initial buffer 242 or the length of the final buffer 246, ε_{Tx} is the nominal clock drift of Alice, and ε_{Rx} is the nominal clock drift of Bob. The MTE determines how long Bob can operate and still capture a new signal in the appropriate timing window allowing Bob to resynchronize with Alice.

If Bob regains some support functions, then Bob may transition from the unsynchronized mode 310 to an operating mode that resynchronizes Bob's local clock with Alice's local clock. If Bob gains the ability to receive data, but remains restricted on the ability to determine its position, then Bob may transition 312 to the coarse unidirectional mode 320. If Bob gains the ability to receive data and the ability to determine its position, then Bob may transition 314 to the fine unidirectional mode 330. If Bob gains the ability to receive data and transmit data, then Bob may transition 316 to the bidirectional mode 340.

In the coarse unidirectional mode 320, Bob receives a time synchronization message and estimates the propagation delay between Bob and Alice to determine an approximate clock offset. In one example, Bob (in the coarse unidirectional mode 320) may estimate the propagation delay based on a predefined operating range between Bob and Alice. For instance, if the wireless link between Bob and Alice is designed to span a maximum of 10 km, then Bob may estimate a distance of 5 km between Bob and Alice to minimize the maximum amount of error. Based on the estimated 5 km distance, Bob may calculate a propagation delay and apply a clock offset correction equal to the estimated propagation delay.

Alternatively, Bob may store a predefined set of estimated distances or propagation delays based on an expected path of Bob relative to Alice. For instance, Bob may be included on a vehicle platform that is tasked for a mission at a predetermined location and a predetermined time. Bob may pre-calculate expected propagation delays based on the expected route of the vehicle platform, or based on known locations of predefined waypoints, which may be recognized by sensors coupled to the vehicle platform and/or Bob.

If Bob (in the coarse unidirectional mode 320) loses the ability to receive time synchronization messages from Alice, then Bob may transition 322 back to the unsynchronized mode of operation. If Bob gains the ability to capture accurate position data (e.g., via a satellite navigation system, through time synchronization messages, etc.), then Bob may transition 324 to the fine unidirectional mode 330. If Bob gains the ability to transmit data, then Bob may transition 326 to the bidirectional mode 340.

In the fine unidirectional mode 330, Bob has the support functions necessary to obtain accurate position information for Bob and/or Alice. With accurate position data, Bob may calculate a more accurate estimate of the distance between Bob and Alice, which leads to a more accurate determination of the propagation delay for messages from Alice to Bob.

In one example, Bob may receive position data as part of the time synchronization message from Alice. For instance, Alice may have additional resources (e.g., satellite access, imaging resources, processing resources, radio resources, etc.) that enable Alice to locate Bob more accurately than Bob is able to detect. Alternatively, Bob may determine its position data by typical geolocation techniques including, but not limited to, satellite positioning data, triangulation from known locations, and/or accelerometer-based techniques. Additionally, either Alice or Bob may be relatively stationary, and Bob may store the location of the stationary device.

In another example, Alice may alter the position data transmitted in the time synchronization message to obscure the exact location of Alice and/or Bob. For instance, the time synchronization message may include position data associated with Alice that indicates Alice is at a different location, which is equidistant from Bob. Alternatively, Alice may include only the actual distance between Alice and Bob in the time synchronization message, if Alice can accurately detect the position of both Alice and Bob.

If Bob (in the fine unidirectional mode 330) loses the ability to receive time synchronization messages from Alice, then Bob may transition 332 back to the unsynchronized mode of operation. If Bob loses the ability to capture accurate position data, then Bob may transition 334 to the coarse unidirectional mode 320. If Bob gains the ability to transmit data, then Bob may transition 336 to the bidirectional mode 340.

In the bidirectional mode 340, Bob has the support functions necessary to receive/send data from/to Alice. With the ability to exchange messages between Alice and Bob, the pair of devices can perform a time synchronization exchange (e.g., NTP, PTP, etc.) to determine an accurate clock offset.

If Bob (in the bidirectional mode 340) loses the ability to receive time synchronization messages from Alice, then Bob may transition 342 back to the unsynchronized mode of operation. If Bob loses both the ability to transmit data to Alice and the ability to capture accurate position data, then Bob may transition 344 to the coarse unidirectional mode 320. If Bob loses the ability to transmit data, but retains the ability to capture accurate position data, then Bob may transition 346 to the fine unidirectional mode 330.

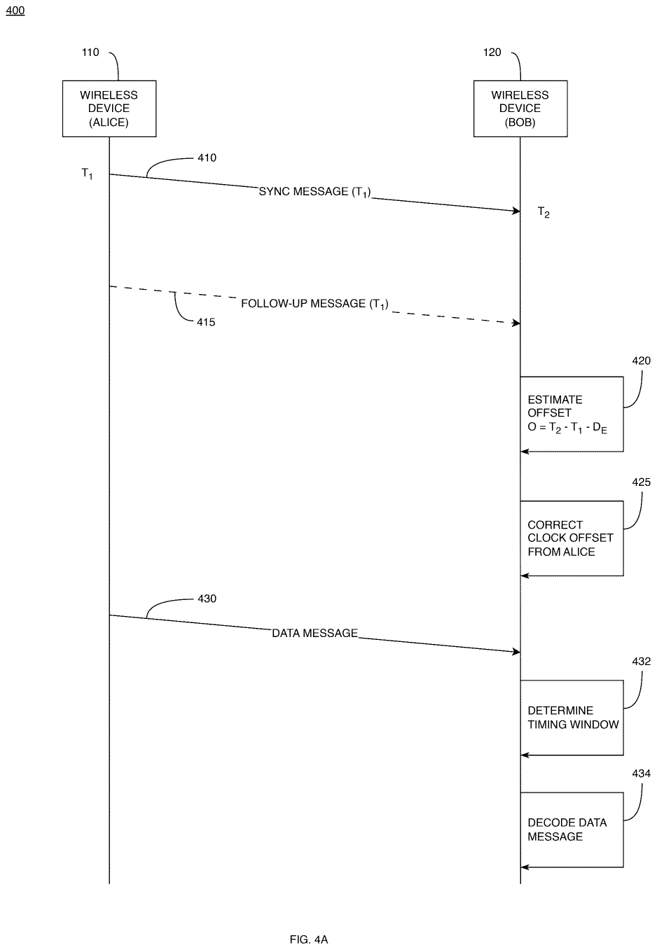

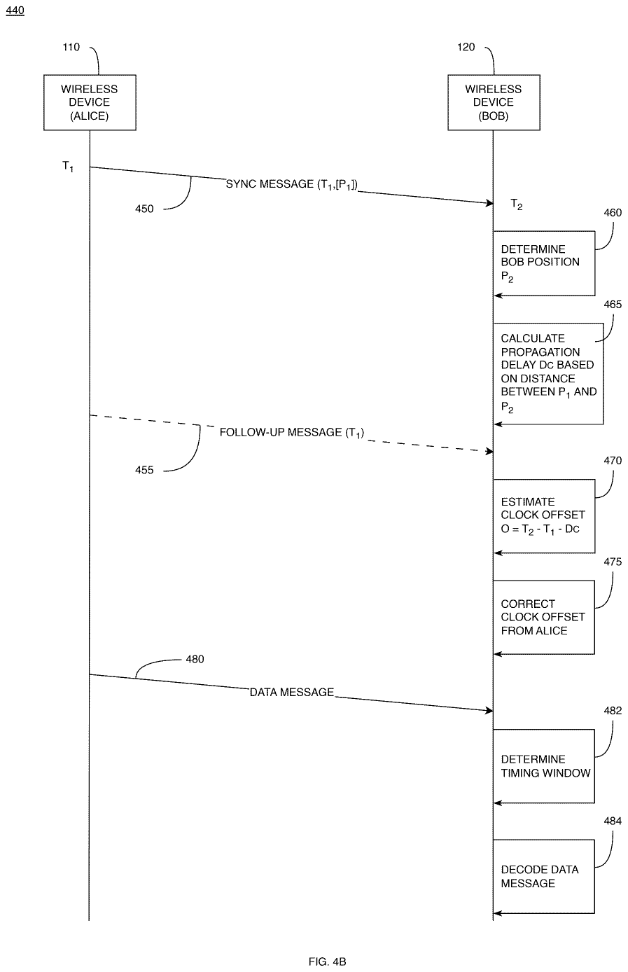

Referring now to FIG. 4A, a message flow diagram 400 illustrates messages exchanged between a first wireless device 110 (Alice) and a second wireless device 120 (Bob) operating in a coarse unidirectional mode. At a time T₁, Alice transmits a time synchronization message 410. Bob detects the time synchronization message 410 and measures the time T₂ that the time synchronization message 410 is received. In one example, the time synchronization message 410 includes an indication of the time T₁. For instance, Alice may construct the time synchronization message 410 with a future time T₁ written into the payload, and schedule the time synchronization message 410 to be transmitted at that time T₁ to ensure that the time indicated in the time synchronization message 410 is accurate. Alternatively, Alice may send a follow-up message 415 that indicates the time T₁ that the time synchronization message 410 was sent. For instance, Alice may not have the resources to schedule transmissions for a specific time. In this instance, Alice may measure the time T₁ when the time synchronization message 410 is actually transmitted, and report that time T₁ to Bob in the follow-up message 415.

Once Bob receives the time T₁ that Alice sent the time synchronization message 410 and has measured the time T₂ that the time synchronization message 410 arrived, Bob estimates the time offset at 420. In the coarse operating mode, Bob estimates the propagation delay D_{E} based on predefined configuration data (e.g., the operating range of the system, an expected distance between Alice and Bob based on mission timing, etc.) and calculates an estimated clock offset O by subtracting the estimated propagation delay D_{E} from the difference in the transmission time T₁ and the received time T₂.

At 425, Bob corrects his local clock based on the estimated clock offset O calculated at 420. Since the propagation delay D_{E} is essentially a guess based on predetermined parameters, the calculated clock offset O may be off if the predetermined parameters are not accurate. For instance, Bob may estimate the propagation delay D_{E} as half of the maximum operating distance of the wireless system to minimize the average timing error over the entire mission, but that distance is not likely to be accurate for much of any specific mission. However, with an estimate for the propagation delay D_{E} of half the maximum operating distance, Bob may expect that the average timing error will be equal to one quarter of the maximum propagation delay based on a randomly chosen separation between Alice and Bob.

After adjusting his local clock to correct the estimated clock offset O, when Bob receives a data message 430, Bob determines a timing window for the data message 430 at 432. Based on parameters associated with the timing window in which Bob begins to receive the data message 430, Bob decodes the data message 430 at 434. In one example, the parameters associated with the timing window may determine aspects (e.g., modulation, coding, cryptography) of how Bob decodes the data message 430. For instance, Alice and Bob may associate a different cryptographic key with each timing window to maintain the cryptographic strength of the wireless system by ensuring that cryptographic keys are only used for a single message. In other words, Alice and Bob may rotate cryptographic keys on a predetermined timing schedule.

Referring now to FIG. 4B, a message flow diagram 440 illustrates messages exchanged between a first wireless device 110 (Alice) and a second wireless device 120 (Bob) operating in a fine unidirectional mode. In the fine unidirectional mode, Bob has the resources to more accurately determine the distance between Alice and Bob, and the corresponding propagation delay. At a time T₁, Alice transmits a time synchronization message 450, which Bob receives at time T₂. In one example, the time synchronization message 450 includes an indication of the transmission time T₁. Alternatively, Alice may send a follow-up message 455 that includes the transmission time T₁ of the time synchronization message 450. Additionally, the time synchronization message 450 may include position information P₁ about Alice. Alternatively, Alice's position P₁ may be effectively fixed at a predetermined position, which may vary in a manner that is preprogrammed into Bob.

At 460, Bob determines his own position P₂. In one example, Bob may determine his position P₂ based on a regional positioning system, a local positioning system, or an inertial positioning system. Alternatively, Bob's position P₂ may be determined externally (e.g., by Alice) and included in the time synchronization message 450. Once Bob has position data P₁ for Alice's position and position data P₂ for Bob's position, Bob calculates a propagation delay D_{c} at 465. The propagation delay D_{c} may be based on the distance between Alice and Bob and the propagation speed of the time synchronization message 450 (i.e., the speed of light). Alternatively, Alice may determine the distance between Alice and Bob and include the determined distance, or the corresponding propagation delay D_{c}, in the time synchronization message 450.

After Bob determines the propagation delay D_{c}, at 470 Bob estimates a clock offset O between Alice's local clock and Bob's local clock. In one example, Bob may estimate the clock offset O by subtracting the calculated propagation delay D_{C} from the difference in the transmission time T₁ and the received time T₂. At 475, Bob adjusts his local clock by the clock offset O to match Alice's clock with significantly better accuracy than the coarse unidirectional mode allows.

Similar to the message flow diagram 400 of FIG. 4A, after adjusting his local clock to correct the estimated clock offset O, when Bob receives a data message 480, Bob determines a timing window for the data message 480 at 482. Based on parameters associated with the timing window in which Bob begins to receive the data message 480, Bob decodes the data message 480 at 484. In one example, the parameters associated with the timing window may determine aspects (e.g., modulation, coding, cryptography) of how Bob decodes the data message 480. With a more accurate estimation of the propagation delay, the fine unidirectional mode shown in FIG. 4B will allow the local clocks on Alice and Bob to be synchronized more accurately and precisely than the coarse unidirectional mode shown in FIG. 4A.

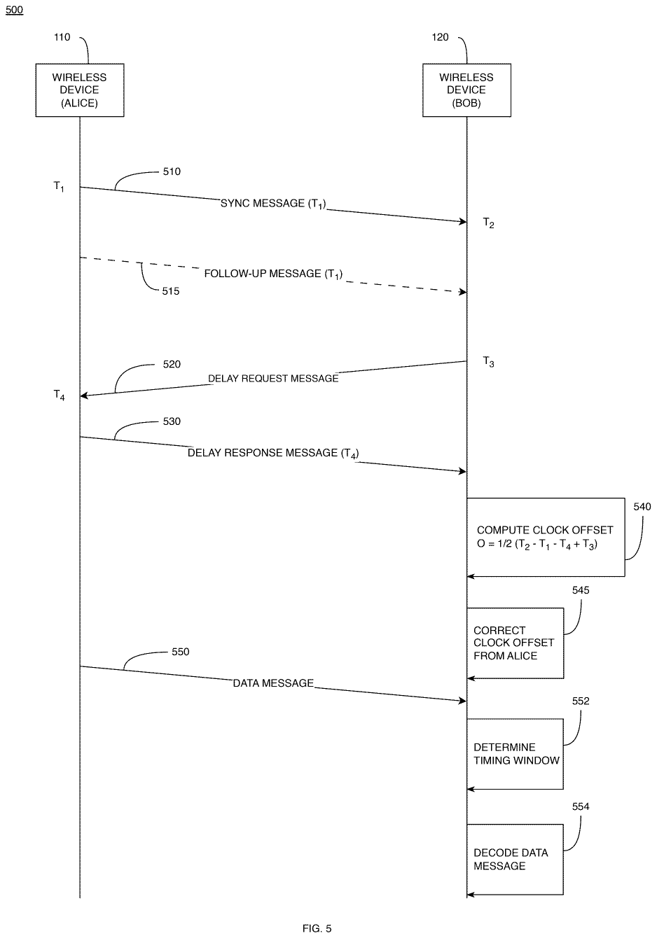

Referring now to FIG. 5, a message flow diagram 500 illustrates messages exchanged between a first wireless device 110 (Alice) and a second wireless device 120 (Bob) operating in a bidirectional mode. In the bidirectional mode, Alice and Bob perform a time synchronization exchange that precisely determines a clock offset, including a propagation delay, without requiring any position data to explicitly calculate the propagation delay.

At a time T₁, Alice transmits a time synchronization message 510, which Bob receives at time T₂. The time synchronization message 510 may include an indication of the time T₁. Alternatively, Alice may send a follow-up message 515 that includes an indication of the time T₁. In response to receiving the time synchronization message 510, Bob sends a delay request message 520 at time T₃, which Alice receives at time T₄. Alice responds with a delay response message 530 that includes an indication of the time T₄ at which Alice received the delay request message 520.

At 540, after Bob receives the delay response message 530, Bob has four time points (i.e., T₁, T₂, T₃, and T₄) that provide sufficient information to separate a clock offset O between the Bob's local clock and Alice's local clock from the propagation delay for transmissions between Alice and Bob. In one example, Bob may calculate the clock offset O as

$$O = \frac{{T}_{2} - {T}_{1} - {T}_{4} + {T}_{3}}{2} ,$$

which Bob uses to correct his local clock to match Alice's local clock at 545.

Similar to the message flow diagrams 400 and 440 of FIG. 4A and FIG. 4B, respectively, after adjusting his local clock to correct the calculated clock offset O, when Bob receives a data message 550, Bob determines a timing window for the data message 550 at 552. Based on parameters associated with the timing window in which Bob begins to receive the data message 550, Bob decodes the data message 550 at 554. In one example, the parameters associated with the timing window may determine aspects (e.g., modulation, coding, cryptography) of how Bob decodes the data message 550. With the ability to transmit and perform a bidirectional time synchronization exchange with Alice, Bob can accurately remove the propagation delay from the calculation of the clock offset without directly calculating the propagation distance/delay. In this example, Bob may use a known or estimated propagation distance/delay to adjust additional wireless parameters (e.g., related to the timing window 240). In other words, Bob may continue to use available positioning information, even if the positioning information is not required for clock synchronization with Alice.

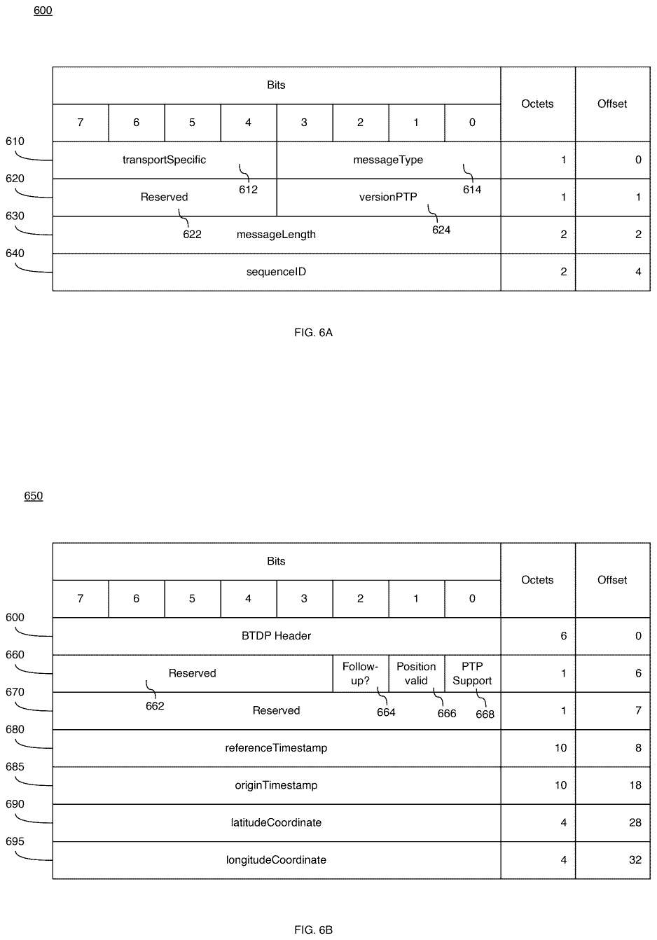

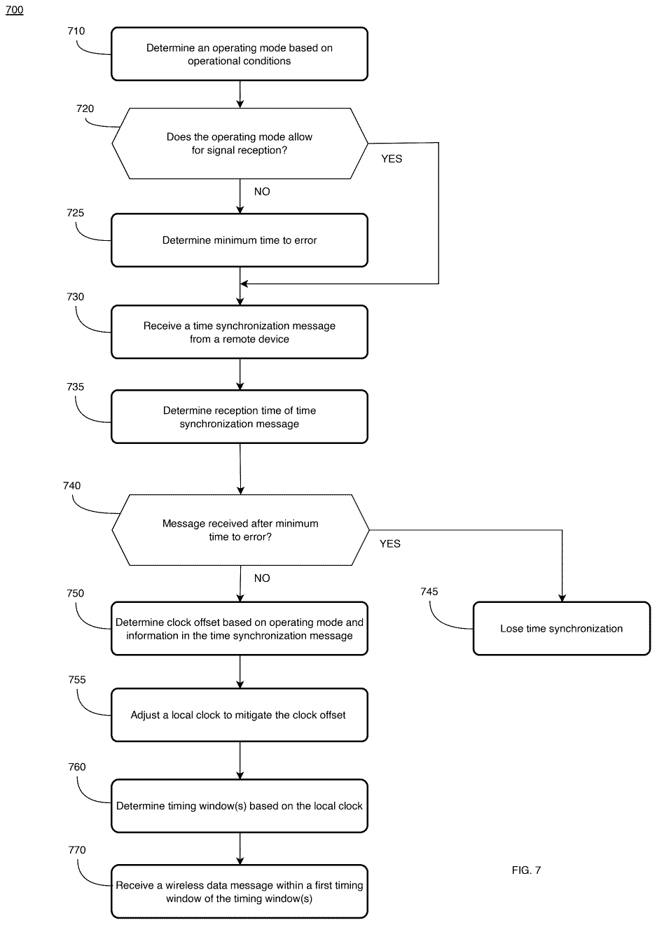

Referring now to FIG. 6A, an example format of a BTDP header 600 is shown. The BTDP header 600 includes six octets of eight bits. The first octet 610 includes a transport field 612 of four bits that identifies a specific protocol (e.g., IEEE 1558 or IEEE 802.1-AS) that may form a basis of the time distribution protocol in a time synchronization domain. The first octet also includes a message type field 614 of four bits that identify what type of message (e.g., a synchronization message, a follow-up message, a delay request message, or a delay response message) follows the BTDP header 600. The second octet 620 of the BTDP header 600 includes a reserved field 622 of four bits that may be reserved for future implementations. The second octet 620 also includes a time protocol version field 624 that identifies a version of a time synchronization protocol (e.g., NTP, PTP, etc.) used by the message following the BTDP header 600.

The third and fourth octets compose a message length field 630 that identifies the length (e.g., in octets) of the message following the BTDP header 600. For instance, if the message following the BTDP header 600 is a synchronization message, as shown in FIG. 6B, the message length field 630 may indicate that the following message is 30 octets or 240 bits long. The fifth and sixth octets compose a sequence identifier field 640 that increments sequentially with each BTDP message sent by a wireless device (e.g., wireless device 110 or wireless device 120) in a BTDP exchange. In one example, the sequence identifier field 640 may be used to detect lost messages and/or spurious messages potentially sent by an adversary. For instance, when a wireless device receives a message with a BTDP header 600 containing a sequence identifier field 640 that is out of sequence in comparison to previous messages, the wireless device may discard the new message (e.g., to mitigate a spoofed messages transmitted by an adversary).

Referring now to FIG. 6B, an example, format of a BTDP time synchronization message 650 is shown. The time synchronization message 650 begins with a BTDP header 600, as shown in FIG. 6A. After the BTDP header 600, the time synchronization message 650 includes an octet 660 that is split into a reserved field 662 of five bits, a one-bit follow-up flag 664, a one-bit position valid flag 666, and a one-bit time synchronization exchange support flag 668. The reserved field 662 is reserved for implementations in future embodiments. The follow-up flag 664 indicates whether a follow-up message will follow the current time synchronization message 650. The position valid flag 666 indicates whether the position data included in the synchronization message is valid. The time synchronization message 650 includes a reserved octet 670 after the octet 660.

Following the reserved octet 670, the synchronization message includes a reference timestamp 680 and an origin timestamp 685 of ten octets each. The reference timestamp 680 may be used to indicate the last time the local clock of the transmitter (e.g., Alice) has been synchronized to a reference clock (e.g., an atomic clock). The origin timestamp 685 may indicate the transmission time of the time synchronization message 650 (e.g., time T₁ from FIGS. 4A, 4B, and 5). In some instances, the origin timestamp 685 may not accurately capture the actual transmission time of the time synchronization message 650. In these instances, a follow-up message will be sent with the accurate transmission time for the time synchronization message 650.

In one example, the reference timestamp 680 and the origin timestamp 685 may encode the time as a number of seconds from a commonly defined reference point in time (e.g., Epoch 1 starting on Jan. 1, 1970). Alternatively, the reference timestamp 680 and the origin timestamp 685 may be defined in terms of a number of seconds from a user defined point in time (e.g., a mission start time or mission synchronization time).

After the reference timestamp 680 and the origin timestamp 685, the time synchronization message 650 includes position data in a latitude field 690 and a longitude field 695. For instance, the latitude field 690 and the longitude field 695 may include a 32-bit signed floating point number indicating latitude and longitude coordinates, respectively. In one example, the latitude field 690 and the longitude field 695 encode the position of the transmitter device (e.g., Alice). In another example, the latitude field 690 and the longitude field 695 encode the position of the receiver device (e.g., Bob) if the transmitter has the capability to accurately locate the receiver device.

In other embodiments, a time synchronization message 650 may include position data for both the transmitter device and the receiver device. Alternatively, the synchronization data may encode distance data or propagation delay in the latitude field 690 and the longitude field 695 if the transmitter device has the capability to accurately determine the positions of both the transmitter device and the receiver device. In general, the latitude field 690 and the longitude field 695 may include any information that enables the receiver device to calculate or estimate the propagation delay based on the distance between the transmitter device and the receiver device.

Referring now to FIG. 7, a flowchart illustrates an example process 700 performed by a wireless device (e.g., Bob or wireless device 120) to maintain time synchronization with a remote device (e.g., Alice or wireless device 110). At 710, the wireless device determines an operating mode based on operational conditions. In one example, the operational conditions may include an ability to transmit and/or receive data. In another example, the operational conditions may include the ability to obtain position data. In a further example, the operating modes may include unsynchronized modes, unidirectional modes, and/or bidirectional modes.

At 720, the wireless device determines whether the operating mode allows the wireless device to receive wireless. In one example, the wireless device may determine that an unsynchronized operating mode does not allow wireless reception. For instance, operational conditions may include an adversary that is effectively prohibiting the remote device from transmitting to the wireless device. If the operating mode does not allow for signal reception (e.g., the operating mode is an unsynchronized mode), then the wireless device determines a minimum time to error at 725. The minimum time to error may be based on hardware specifications of the wireless device and the remote device. For instance, the maximum drift rate of a local clock on the wireless device and a remote clock on the remote device. Additionally, the minimum time to error may depend on predefined wireless reception parameters, such as the length of buffers on a timing window. If the operating mode allows for wireless signal reception, then the wireless device may skip the determination of the minimum time to error. Alternatively, the wireless device may always determine the minimum time to error in operating modes that allow for wireless signal reception.

At 730, the wireless device receives a time synchronization message from the remote device. In one example, the time synchronization message includes a timestamp indicating the transmission time T₁ at which the time synchronization message was transmitted. In another example, the time synchronization message may include position information associated with the wireless device and/or the remote device. At 735, the wireless device determines the reception time T₂ at which the wireless device received the time synchronization message.

If the time synchronization message was received after the minimum time to error, as determined at 740, then the wireless device may not be able to properly decode the time synchronization message. In this instance, the wireless device loses time synchronization with the remote device at 745. In one example, the wireless device and the remote device may recover time synchronization through a separate, and potentially less secure, process that is outside the scope of the techniques presented herein.

If the time synchronization message was received within the minimum time to error, as determined at 740, then the wireless device determines a clock offset between the local clock of the wireless device and the remote clock of the remote device at 750. The wireless device determines the clock offset based on the operating mode of the wireless device and information in time synchronization message (e.g., the transmission time T₁ and/or position information). At 755, the wireless device adjusts the local clock to mitigate the clock offset between the local clock the remote clock of the remote device.

At 760, the wireless device determines at least one timing window based on the local clock. In one example, the timing window may include a nominal reception window and buffer window(s) before and/or after the nominal reception window. At 770, the wireless device receives a wireless data message that begins within a first timing window of the at least one timing window. In one example, the first timing window is associated with a first set of parameters (e.g., modulation, coding, cryptography) that enable the wireless device to parse the wireless data message. In another example, the wireless data message may begin within the first timing window, but extend beyond the first timing window.

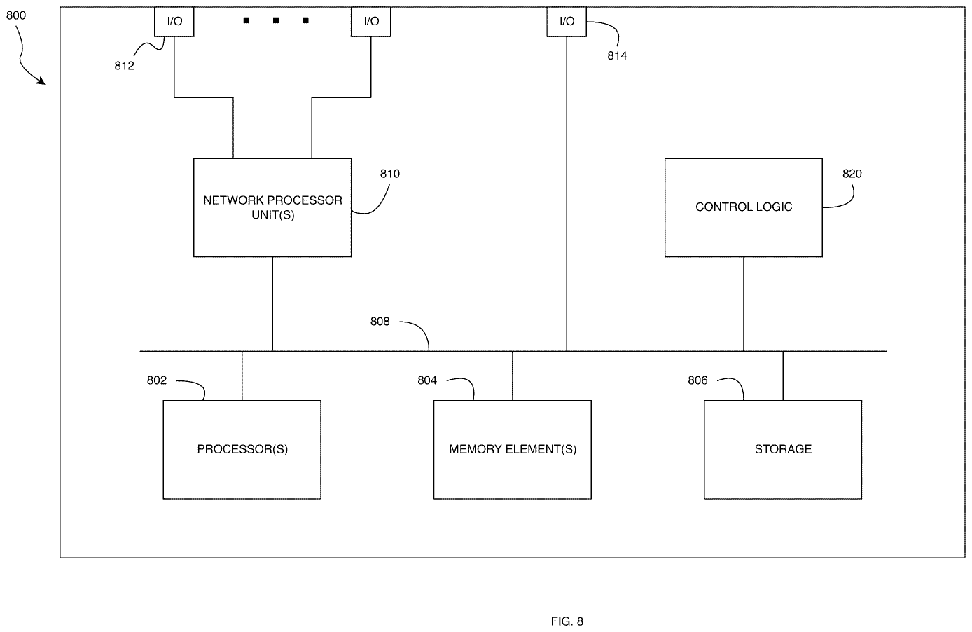

Referring now to FIG. 8, a hardware block diagram depicts a computing device 800 that may perform functions associated with operations described herein in connection with the techniques depicted in FIGS. 1, 2A, 2B, 3, 4A, 4B, 5, 6A, 6B, and 7. In various embodiments, a computing device, such as computing device 800 or any combination of computing devices 800, may be configured as any entity/entities as discussed for the techniques depicted in connection with FIGS. 1, 2A, 2B, 3, 4A, 4B, 5, 6A, 6B, and 7 in order to perform operations of the various techniques discussed herein. In some instances, one or more computing devices 800 (e.g., servers) may be deployed in a cloud or distributed computing environment to perform one or more of the techniques described herein.

In at least one embodiment, the computing device 800 may include one or more processor(s) 802, one or more memory element(s) 804, storage 806, a communication bus 808, one or more network processor unit(s) 810 interconnected with one or more network input/output (I/O) interface (s) 812, and control logic 820. In various embodiments, instructions associated with logic for computing device 800 may overlap in any manner and are not limited to the specific allocation and/or operations described herein.

In at least one embodiment, processor(s) 802 is/are at least one hardware processor configured to execute various tasks, operations, and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information, etc.) from one state or thing to another state or thing. Any of potential processing elements, microprocessors, digital signal processors, floating point gate arrays (FPGAs), graphical processor units (GPUs), secure processors, baseband signal processors, modems, PHY elements, controllers, systems, managers, logic, and/or machines described herein can be construed as being encompassed within the broad term ‘processor.’

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, communication bus 808 can be configured as an interface that enables one or more elements of computing device 800 to communicate in order to exchange information and/or data. Communication bus 808 can be implemented with any architecture designed for passing control, data, and/or information between processors, memory elements/storage, peripheral devices, and/or any other hardware and/or software components that may be configured for computing device 800. In at least one embodiment, communication bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface card(s), optical (e.g., Fibre Channel) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc., to facilitate operations for various embodiments described herein. In various embodiments, network I/O interface(s) 812 can be configured as one or more Ethernet port(s), Fibre Channel port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, touch screen, microphone or microphone array, camera, video capture device, and/or other suitable input and/or output device now known or hereafter developed. In some instances, external devices may also include portable computer readable (non-transitory) storage media such as database systems, flash memory drives, portable optical or magnetic disks, and/or other memory cards. In some instances, external devices may include a mechanism to display data to a user, such as a computer monitor, a display screen, an audio speaker, and/or other output device.

In various embodiments, control logic 820, can include instructions that, when executed, cause processor(s) 802 to perform operations, which can include, but not be limited to, providing overall control operations of computing devices; interacting with other entities, systems, etc., described herein; maintaining and/or interacting with stored data, information, parameters, etc. (e.g., memory element(s), storage, data structures, databases, tables, etc.); combinations thereof, and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), secure memory module, tamper-proof memory, application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure; all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in an Application Specific Integrated Circuit (ASIC), Digital Signal Processing (DSP) instructions, software (potentially inclusive of object code and/or source code), etc.) for execution by one or more processor(s), and/or other similar machines. Generally, memory element(s) 804 and/or storage 806 may store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, and/or the like that are executed to carry out operations in accordance with the teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, flash drives, and/or smart cards that can be inserted and/or otherwise connected to a computing device for transfer onto another computer readable storage medium.

### Variations and Implementations

As used herein, a ‘transmitter’ (or ‘signal transmitter’) refers to any collection of components that are used in the transmission of signals, including any combination of, but limited to, one or more: antennas, amplifiers, cables, digital-to-analog converters, analog-to-digital converters, filters, up-converters, encoders, modulators, multiplexers, processors (e.g., for reading bits and/or mapping of bits to a baseband), control circuitry, oscillators, etc. Similarly, as used herein, a ‘receiver’ (or ‘signal receiver’) refers to any collection of components that are used in receiving signals, including any combination of, but limited to, one or more: antennas, amplifiers, cables, analog-to-digital converters, digital-to-analog converters, filters, down-converters, decoders, demodulators, demultiplexers, processors, detectors, control circuitry, oscillators, etc. Further the transmitter and receiver may be implemented using analog components, digital components, or a mix of analog and digital components. Further the transmitter and receiver may use analog signals, digital signals, or a mix of analog and digital signals.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium.

Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/6G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly be connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of, ‘one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and ‘one or more of can be represented using the ‘(s)’ nomenclature (e.g., one or more element(s)).

In summary, the BTDP techniques presented herein enable a wireless communication session to reliably persist as environmental and operational conditions change. The timing synchronization of the wireless communication session improves as more resources become available to the wireless devices. Similarly, the timing synchronization gracefully degrades as resources become unavailable. If conditions degrade beyond a critical point, a wireless device may determine how long the timing synchronization may be maintained based on the BTDP parameters, such as the length of the timing window. The BTDP parameters may be configured to balance the latency of the wireless communication session and the length of time that a degraded session may maintain timing synchronization.

In some aspects, the techniques described herein relate to a method including: determining an operating mode of a wireless device based on operational conditions of the wireless device; receiving a time synchronization message from a remote device; determining a clock offset between a local clock of the wireless device and a remote clock of the remote device based on the operating mode and information in the time synchronization message; adjusting the local clock of the wireless device to mitigate the clock offset between the local clock and the remote clock; determining at least one timing window based on the local clock; and receiving a wireless data message beginning within a first timing window of the at least one timing window.

In some aspects, the techniques described herein relate to a method, further including processing the wireless data message using a first set of parameters associated with the first timing window.

In some aspects, the techniques described herein relate to a method, wherein the first set of parameters includes cryptographic material associated with the first timing window.

In some aspects, the techniques described herein relate to a method, wherein the operational conditions of the wireless device include restrictions on wireless signal reception, wireless signal transmission, or position determination.

In some aspects, the techniques described herein relate to a method, wherein the operating mode is a unidirectional mode, the method further including: determining a distance between the wireless device and the remote device; and calculating a propagation delay based on the distance between the wireless device and the remote device, wherein adjusting the local clock includes removing the propagation delay from the clock offset between the local clock and the remote clock.

In some aspects, the techniques described herein relate to a method, wherein the distance between the wireless device and the remote device is based on position information included in the time synchronization message.

In some aspects, the techniques described herein relate to a method, wherein the distance between the wireless device and the remote device is based on a predetermined position of the remote device.

In some aspects, the techniques described herein relate to a method, wherein the distance between the wireless device and the remote device is based on a predefined operating range for communications between the wireless device and the remote device.

In some aspects, the techniques described herein relate to a method, wherein the operating mode is a bidirectional mode, the method further including performing a time synchronization exchange with the remote device to determine the clock offset.

In some aspects, the techniques described herein relate to an apparatus including: a local clock configured to provide timing for wireless communications; a wireless receiver module configured to receive wireless transmissions; and a processor configured to: determine an operating mode of the apparatus based on operational conditions of the apparatus; receive via the wireless receiver module, a time synchronization message from a remote device; determine a clock offset between the local clock and a remote clock of the remote device based on the operating mode and information in the time synchronization message; adjust the local clock to mitigate the clock offset between the local clock and the remote clock; determine at least one timing window based on the local clock; and receiving a wireless data message via the wireless receiver module, the wireless data message beginning within a first timing window of the at least one timing window.

In some aspects, the techniques described herein relate to an apparatus, wherein the processor is further configured to process the wireless data message using a first set of parameters associated with the first timing window.

In some aspects, the techniques described herein relate to an apparatus, wherein the processor is further configured to process the wireless data message using cryptographic material in the first set of parameters associated with the first timing window.

In some aspects, the techniques described herein relate to an apparatus, wherein the operational conditions of the apparatus include restrictions on wireless signal reception, wireless signal transmission, or position determination.

In some aspects, the techniques described herein relate to an apparatus, wherein the operating mode is a unidirectional mode, the processor further configured to: determine a distance between the apparatus and the remote device; and calculate a propagation delay based on the distance between the apparatus and the remote device, wherein the processor is configured to adjust the local clock by removing the propagation delay from the clock offset between the local clock and the remote clock.

In some aspects, the techniques described herein relate to an apparatus, wherein the processor is configured to determine the distance between the apparatus and the remote device based on position information included in the time synchronization message.

In some aspects, the techniques described herein relate to an apparatus, wherein the processor is configured to determine the distance between the apparatus and the remote device based on a predetermined position of the remote device.

In some aspects, the techniques described herein relate to an apparatus, wherein the processor is configured to determine the distance between the apparatus and the remote device based on a predefined operating range for communications between the apparatus and the remote device.

In some aspects, the techniques described herein relate to an apparatus, wherein the operating mode is a bidirectional mode, the apparatus further including a wireless transmitter module configured to transmit wireless signals, wherein the processor is further configured to perform a time synchronization exchange with the remote device to determine the clock offset.

In some aspects, the techniques described herein relate to a method including: determining at least one timing window based on a local clock of a wireless device; determining an operating mode of the wireless device is an unsynchronized mode based on operational conditions preventing the wireless device from receiving wireless signals; calculating a minimum time to error based on a length of the at least one timing window and a maximum clock drift between the local clock and a remote clock of a remote device; responsive to detecting that new operational conditions of the wireless device allow wireless reception at the wireless device, transitioning the operating mode of the wireless device to a new operating mode; receiving a time synchronization message from the remote device; determining a clock offset between the local clock and the remote clock based on the new operating mode and information in the time synchronization message; and adjusting the local clock of the wireless device to mitigate the clock offset between the local clock and the remote clock.

In some aspects, the techniques described herein relate to a method, wherein the new operating mode is selected from a bidirectional mode, a fine unidirectional mode, or a coarse unidirectional mode.

In some aspects, the techniques described herein relate to a method, wherein the new operating mode is a unidirectional mode, the method further including: determining a distance between the wireless device and the remote device; and calculating a propagation delay based on the distance between the wireless device and the remote device, wherein adjusting the local clock includes removing the propagation delay from the clock offset between the local clock and the remote clock.

In some aspects, the techniques described herein relate to a method, wherein the new operating mode is a bidirectional mode, the method further including performing a time synchronization exchange with the remote device to determine the clock offset.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
determining an operating mode of a wireless device based on operational conditions of the wireless device;
receiving a time synchronization message from a remote device;
determining a clock offset between a local clock of the wireless device and a remote clock of the remote device based on the operating mode and information in the time synchronization message;
adjusting the local clock of the wireless device to mitigate the clock offset between the local clock and the remote clock;
determining at least one timing window based on the local clock; and
receiving a wireless data message beginning within a first timing window of the at least one timing window.

2. The method of claim 1, further comprising processing the wireless data message using a first set of parameters associated with the first timing window.

3. The method of claim 2, wherein the first set of parameters includes cryptographic material associated with the first timing window.

4. The method of claim 1, wherein the operational conditions of the wireless device include restrictions on wireless signal reception, wireless signal transmission, or position determination.

5. The method of claim 1, wherein the operating mode is a unidirectional mode, the method further comprising:
determining a distance between the wireless device and the remote device; and
calculating a propagation delay based on the distance between the wireless device and the remote device, wherein adjusting the local clock comprises removing the propagation delay from the clock offset between the local clock and the remote clock.

6. The method of claim 5, wherein the distance between the wireless device and the remote device is based on position information included in the time synchronization message.

7. The method of claim 5, wherein the distance between the wireless device and the remote device is based on a predetermined position of the remote device.

8. The method of claim 5, wherein the distance between the wireless device and the remote device is based on a predefined operating range for communications between the wireless device and the remote device.

9. The method of claim 1, wherein the operating mode is a bidirectional mode, the method further comprising performing a time synchronization exchange with the remote device to determine the clock offset.

10. An apparatus comprising:
a local clock configured to provide timing for wireless communications;
a wireless receiver module configured to receive wireless transmissions; and
a processor configured to:
determine an operating mode of the apparatus based on operational conditions of the apparatus;
receive via the wireless receiver module, a time synchronization message from a remote device;
determine a clock offset between the local clock and a remote clock of the remote device based on the operating mode and information in the time synchronization message;
adjust the local clock to mitigate the clock offset between the local clock and the remote clock;
determine at least one timing window based on the local clock; and
receiving a wireless data message via the wireless receiver module, the wireless data message beginning within a first timing window of the at least one timing window.

11. The apparatus of claim 10, wherein the processor is further configured to process the wireless data message using a first set of parameters associated with the first timing window.

12. The apparatus of claim 11, wherein the processor is further configured to process the wireless data message using cryptographic material in the first set of parameters associated with the first timing window.

13. The apparatus of claim 10, wherein the operational conditions of the apparatus include restrictions on wireless signal reception, wireless signal transmission, or position determination.

14. The apparatus of claim 10, wherein the operating mode is a unidirectional mode, the processor further configured to:
determine a distance between the apparatus and the remote device; and
calculate a propagation delay based on the distance between the apparatus and the remote device, wherein the processor is configured to adjust the local clock by removing the propagation delay from the clock offset between the local clock and the remote clock.

15. The apparatus of claim 14, wherein the processor is configured to determine the distance between the apparatus and the remote device based on position information included in the time synchronization message.

16. The apparatus of claim 14, wherein the processor is configured to determine the distance between the apparatus and the remote device based on a predetermined position of the remote device.

17. The apparatus of claim 14, wherein the processor is configured to determine the distance between the apparatus and the remote device based on a predefined operating range for communications between the apparatus and the remote device.

18. The apparatus of claim 10, wherein the operating mode is a bidirectional mode, the apparatus further comprising a wireless transmitter module configured to transmit wireless signals,
wherein the processor is further configured to perform a time synchronization exchange with the remote device to determine the clock offset.

19. A method comprising:
determining at least one timing window based on a local clock of a wireless device;
determining an operating mode of the wireless device is an unsynchronized mode based on operational conditions restricting the wireless device from receiving wireless signals;
calculating a minimum time to error based on a length of the at least one timing window and a maximum clock drift between the local clock and a remote clock of a remote device;
responsive to detecting that new operational conditions of the wireless device allow wireless reception at the wireless device, transitioning the operating mode of the wireless device to a new operating mode;
receiving a time synchronization message from the remote device;
determining a clock offset between the local clock and the remote clock based on the new operating mode and information in the time synchronization message; and
adjusting the local clock of the wireless device to mitigate the clock offset between the local clock and the remote clock.

20. The method of claim 19, wherein the new operating mode is selected from a bidirectional mode, a fine unidirectional mode, or a coarse unidirectional mode.

21. The method of claim 19, wherein the new operating mode is a unidirectional mode, the method further comprising:
determining a distance between the wireless device and the remote device; and
calculating a propagation delay based on the distance between the wireless device and the remote device, wherein adjusting the local clock comprises removing the propagation delay from the clock offset between the local clock and the remote clock.

22. The method of claim 19, wherein the new operating mode is a bidirectional mode, the method further comprising performing a time synchronization exchange with the remote device to determine the clock offset.
